(19) United States
(12) Patent Application Publication
(10) Pub. No.: US 2013/0085248 A1
(43) Pub. Date: Apr. 4, 2013

(54) POLYMERS PREPARED FROM MIXTURES OF MULTIFUNCTIONAL N-VINYLFORMAMIDE AND HYBRID REACTIVE N-VINYLFORMAMIDE CROSSLINKING MONOMER MOIETIES AND USES THEREOF

(71) Applicants: Osama M. Musa, Kinnelon, NJ (US); Ilya Makarovsky, Fair Lawn, NJ (US); Cuiyue Lei, Wayne, NJ (US)

(72) Inventors: Osama M. Musa, Kinnelon, NJ (US); Ilya Makarovsky, Fair Lawn, NJ (US); Cuiyue Lei, Wayne, NJ (US)

(73) Assignee: ISP Investments Inc., Wilmington, DE (US)

(21) Appl. No.: 13/520,810

(22) PCT Filed: Jan. 5, 2011
(86) PCT No.: PCT/US11/20208

§ 371 Date: Oct. 3, 2012

Related U.S. Application Data
(60) Provisional application No. 61/292,897, filed on Jan. 7, 2010.

(51) Int. Cl. C08F 236/20

(52) U.S. Cl. CPC C08F 236/20
USPC 526/264; 526/312

(57) ABSTRACT

The present invention provides polymers resulting from polymerization of at least one reactive vinyl monomer moiety and a multifunctional N-vinylformamide crosslinking moiety; polymers resulting from polymerization of at least one reactive vinyl monomer moiety and a hybrid N-vinylformamide crosslinking moiety having at least one N-vinylformamide functionality and at least one other reactive vinyl functionality; polymers resulting from polymerization of at least one hybrid reactive N-vinylformamide monomer moiety having one N-vinylformamide functionality and at least one other reactive non-vinyl functionality and a multifunctional N-vinylformamide crosslinking moiety; and polymers resulting from polymerization of at least one hybrid reactive N-vinylformamide monomer moiety having one N-vinylformamide functionality and at least one other reactive non-vinyl functionality and a hybrid N-vinylformamide crosslinking moiety having at least one N-vinylformamide functionality and at least one other reactive vinyl functionality. The invention further provides a wide variety of compositions comprising the novel crosslinked polymers.

### BACKGROUND OF THE INVENTION

1. Field of the Invention

The present invention provides polymers resulting from polymerization of at least one reactive vinyl monomer moiety and a multifunctional N-vinylformamide crosslinking moiety; polymers resulting from polymerization of at least one reactive vinyl monomer moiety and a hybrid N-vinylformamide crosslinking moiety having at least one N-vinylformamide functionality and at least one other reactive vinyl functionality; polymers resulting from polymerization of at least one hybrid reactive N-vinylformamide monomer moiety having one N-vinylformamide functionality and at least one other reactive non-vinyl functionality and a multifunctional N-vinylformamide crosslinking moiety; and polymers resulting from polymerization of at least one hybrid reactive N-vinylformamide monomer moiety having one N-vinylformamide functionality and at least one other reactive non-vinyl functionality and a hybrid N-vinylformamide crosslinking moiety having at least one N-vinylformamide functionality and at least one other reactive vinyl functionality. The invention further provides a wide variety of compositions comprising the novel crosslinked polymers.

2. Description of Related Art

N-vinylamides are electron rich monomers. Commonly known cyclic N-vinylamides include N-vinylpyrrolidinone (NVP) and N-vinyl-caprolactam (NVCL), and commonly known acyclic N-vinylamides are N-vinylacetamide (NVA) and N-vinylformamide (NVF). Multifunctional N-vinylformamide crosslinking compounds are moieties having at least two N-vinylformamide functionalities and no other reactive functionalities. Hybrid N-vinylformamide crosslinking moieties are moieties having at least one N-vinylformamide functionality and at least one other reactive vinyl functionality that is not a N-vinylformamide functionality.

The synthesis of N-vinylamides can be accomplished through the vinylation reaction of amide through addition to acetylene, or through a trans-vinylation reaction with vinyl ether or vinyl acetate. N-vinylamides can also be prepared by cracking a vinylamide precursor. The synthesis of multifunctional N-vinylamide compounds can proceed through a C-alkylation reaction using a lithium base, or through the use of an N-alkylation reaction requiring the use of sodium hydride (NaH), which is typically not preferred in industrial manufacturing environments. In another method, N-vinylacetamide can be de-protonated by NaOH in the presence of a phase transfer catalyst to create difunctional monomers that can be used to make polymers with cyclic backbones. Michael addition of N-vinylformamides to acrylonitrile and to acrylates and methacrylates has been used for the synthesis of N-cyanoethyl-N-vinyl-formamide and 3-(N-vinylformamido)propionates, respectively. In both cases, the synthesis was focused on monofunctional substituted N-vinylamides. The synthetic routes disclosed above relate to either multifunctional N-vinylacetamide or N-vinylpyrrolidone, or to monofunctional N-vinylformamides.

Crosslinking agents (crosslinkers) arc bonds that link one polymer chain to another and usually result in a difference in the physical properties of the polymer. Crosslinking agents contain at least two reactive groups that are reactive towards numerous groups. The extent of crosslinking and specificities of the crosslinking agents vary. The resulting modification of mechanical properties depends strongly on the crosslink density. Low crosslinking densities raise the viscosities of polymer melts. Intermediate crosslinking densities transform gummy polymers into materials that have elastomeric properties and potentially high strengths. Very high crosslinking densities can cause materials to become very rigid or glassy, such as phenol-formaldehyde materials. The presence of crosslinked networks is advantageous to improve the molecular weight control, control the swelling volume, and improve the thickening property. Crosslinkers are available with different spacer arm lengths. A crosslinker with a longer space arm may be used where two target groups are further apart. The availability of crosslinkers with different spacer arms allows optimization of cross-reaction efficiency. Crosslinkers with short space arms are suitable for intramolecular crosslinking.

The general class of lactam polymers, including polyvinylpyrrolidone (PVP), are well known, as described for example in Robinson, B. V., Sullivan, F. M., Borzelleca, J. F., Schwartz, S. L.; “PVP: A Critical Review of the Kinetics and Toxicology of Polyvinylpyrrolidone (Povidone)”, 1990, Lewis Publishers, InC, Chelsea, Mich.; U.S. Pat. Nos. 3,153,640, 2,927,913, 3,532,679; and Great Britain Patent no. 811,135. PVP has been used extensively in medicine since 1939. The toxicity of PVP has been studied extensively in a variety of species, including humans and other primates, and is extremely low.

Disclosures discussing crosslinkers and N-vinylformamides include WO 2009/099436, WO 2007/096400, WO 2008/032342, and U.S. Pat. Nos. 5,300,606, 5,788,950, 5,338,815, and 5,534,174.

Accordingly, there is a need for crosslinked polymers to improve the physical and mechanical properties of polymers.

### SUMMARY OF THE INVENTION

The present invention provides polymers resulting from polymerization of at least one reactive vinyl monomer moiety and a multifunctional N-vinylformamide crosslinking moiety.

The present invention also provides polymers resulting from polymerization of at least one reactive vinyl monomer moiety and a hybrid N-vinylformamide crosslinking moiety having at least one N-vinylformamide functionality and at least one other reactive vinyl functionality.

The present invention further provides polymers resulting from polymerization of at least one hybrid reactive N-vinylformamide monomer moiety having one N-vinylformamide functionality and at least one other reactive non-vinyl functionality and a multifunctional N-vinylformamide crosslinking moiety.

The present invention still further provides polymers resulting from polymerization of at least one hybrid reactive N-vinylformamide monomer moiety having one N-vinylformamide functionality and at least one other reactive non-vinyl functionality and a hybrid N-vinylformamide crosslinking moiety having at least one N-vinylformamide functionality and at least one other reactive vinyl functionality.

The present invention further provides a wide variety of compositions comprising the above polymers.

### DETAILED DESCRIPTION OF THE INVENTION

The present invention provides polymers resulting from polymerization of at least one reactive vinyl monomer moiety and multifunctional N-vinylformamide crosslinking moieties or hybrid N-vinylformamide moieties, and combinations thereof.

The invention further provides a wide variety of compositions comprising the novel crosslinked polymers including adhesives, aerosols, agricultural compositions, beverages, cleaning compositions, coating compositions, cosmetic formulations, dental compositions, detergents, drugs, encapsulations, foods, hair sprays, lithographic solutions, membrane formulations, oilfield formulations, personal care compositions, pharmaceuticals, pigment dispersions, and the like. Personal care compositions refers to such illustrative non-limiting compositions as skin, sun, oil, hair, cosmetic, and preservative compositions, including those to alter the color and appearance of the skin. Other personal care compositions include, but are not limited to, polymers for increased flexibility in styling, durable styling, increased humidity resistance for hair, skin, and color cosmetics, sun care water-proof/resistance, wear-resistance, and thermal protecting/enhancing compositions. Dental personal care compositions include denture adhesives, toothpastes, mouth washes, and the like. Pharmaceutical compositions include tablet coatings, tablet binders, transdermal patches, and the like.

As setout above, commonly known electron rich N-vinylamides include N-vinylacetamide (NVA), N-vinyl-caprolactam (NVCL), N-vinylformamide (NVF), and N-vinylpyrrolidinone (NVP).

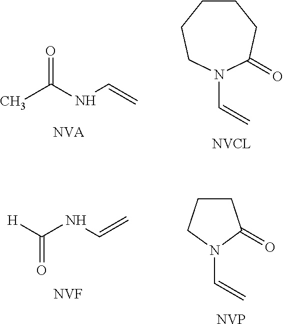

As used herein, the following terms have the meanings set out below.

The term “branched and unbranched alkyl groups” refers to alkyl groups, which may be straight chained or branched. Preferably, the alkyl groups have from 1 to 6 carbon atoms. Branched groups include isopropyl, tert-butyl, and the like.

The term “crosslinkers” or crosslinker agents” refers to crosslinkers or agents that contain at least two reactive groups that are reactive towards numerous groups. The extent of crosslinking and specificities of the crosslinking agents vary.

The term “heteroatom” refers to atoms such as oxygen, nitrogen, sulfur, and phosphorous.

The term “hybrid reactive N-vinylformamide monomer moiety having one N-vinylformamide functionality and at least one other reactive non-vinyl functionality” refers to moieties having one N-vinylformamide functionality and at least one other reactive functionality that is a non-vinyl functionality. The at least one other reactive non-vinyl functionality in the hybrid reactive N-vinylformamide monomer moiety having one N-vinylformamide functionality and at least one other reactive non-vinyl functionality may be selected from the group consisting of epoxides, oxetanes, benzoxazines, oxazolines, and mixtures thereof. Preferred illustrative examples of such moieties have the structures set out below:

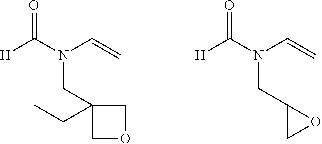

The term “hybrid N-vinylformamide crosslinking moiety having at least one N-vinylformamide functionality and at least one other reactive vinyl functionality” refers to moieties having at least one N-vinylformamide functionality and at least one other reactive vinyl functionality that is not a N-vinylformamide functionality. Illustrative examples of such moieties have the structures set out below:

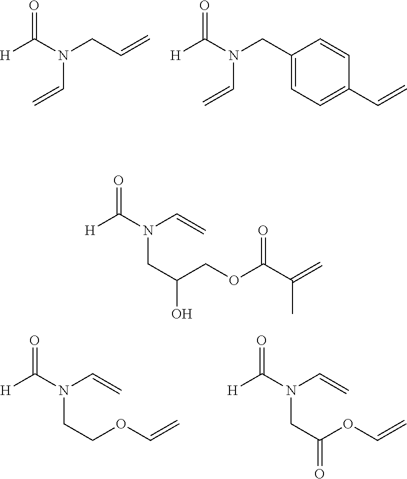

The term “K-Value” is a number calculated from a dilute solution viscosity measurement of a polymer. The number is used to denote the degree of polymerization or molecular size.

The term “multifunctional N-vinylformamide crosslinking moiety” refers to moieties having at least two N-vinylformamide functionalities and no other reactive functionalities. Illustrative examples of such moieties have the structures set out below:

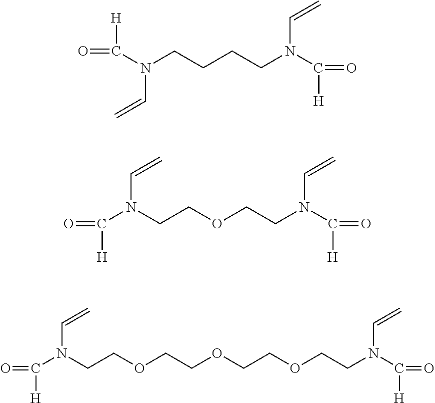 [SMILES: C=CN(C=O)CCCCN(C=C)C=O ; C=CN(C=O)CCOCCN(C=C)C=O ; C=CN(C=O)CCOCCOCCOCCN(C=C)C=O]

The term “polymer” refers to a large molecule (macromolecule) composed of repeating structural units (monomers) connected by covalent chemical bonds.

The term “reactive monomer moiety” refers to monomer moieties reactive with multifunctional N-vinylformamide crosslinking moieties and hybrid N-vinylformamide crosslinking moieties. Non-limiting illustrative examples of reactive monomer moieties include anhydrides, vinyl amides, acrylates, styrenes, malcimides, malcates, fumarates, cinnamyls, vinyl imidazoles, vinyl pyridines, vinyl acetates, acrylamides, vinyl sulfones, vinyl carbonates, vinyl silanes, vinyl acrylamides, allyl derivatives, vinyl ethers, epoxides, oxetanes, benzoxazines, oxazolines, and mixtures thereof.

The present invention provides polymers resulting from polymerization of at least one reactive vinyl monomer moiety and a multifunctional N-vinylformamide crosslinking moiety.

Preferred reactive monomer moieties may be selected from the group consisting of maleic anhydrides, vinyl amides, acrylates, styrenes, malcimides, malcates, fumarates, cinnamyls, vinyl imidazoles, vinyl pyridines, vinyl acetates, acrylamides, vinyl sulfones, vinyl carbonates, vinyl silanes, vinyl acrylamides, allyl derivatives, vinyl ethers, and mixtures thereof.

Preferred multifunctional N-vinylformamide crosslinking moieties may be selected from the group consisting of:

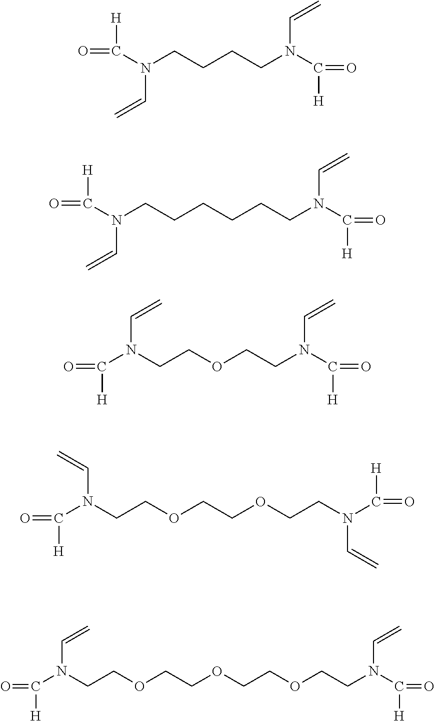 [SMILES: C=CN(C=O)CCCCN(C=C)C=O ; C=CN(C=O)CCCCCCN(C=C)C=O ; C=CN(C=O)CCOCCN(C=C)C=O ; C=CN(C=O)CCOCCOCCN(C=C)C=O ; C=CN(C=O)CCOCCOCCOCCN(C=C)C=O]

More preferred multifunctional N-vinylformamide crosslinking moieties may be selected from the group consisting of:

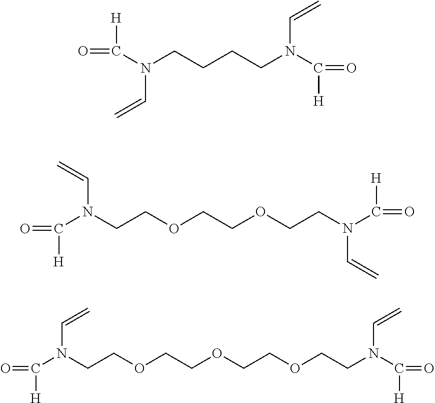

The present invention further provides compositions comprising a polymer resulting from polymerization of at least one reactive vinyl monomer moiety and a multifunctional N-vinylformamide crosslinking moiety. Preferred compositions are adhesive, agricultural, beverage, cleaning, coating, encapsulation, membrane, personal care, and oilfield compositions. Preferred reactive monomer moieties and multifunctional N-vinylformamide crosslinking moieties are as defined above.

The present invention further provides a polymer resulting from polymerization of at least one reactive vinyl monomer moiety and a hybrid N-vinylformamide crosslinking moiety having at least one N-vinylformamide functionality and at least one other reactive vinyl functionality.

Preferred reactive monomer moieties may be selected from the group consisting of maleic anhydrides, vinyl amides, acrylates, styrenes, maleimides, maleates, fumarates, cinnamyls, vinyl imidazoles, vinyl pyridines, vinyl acetates, acrylamides, vinyl sulfones, vinyl carbonates, vinyl silanes, vinyl acrylamides, allyl derivatives, vinyl ethers, and mixtures thereof.

Preferred hybrid N-vinylformamide crosslinking moieties having at least one N-vinylformamide functionality and at least one other reactive vinyl functionality may be selected from the group consisting of:

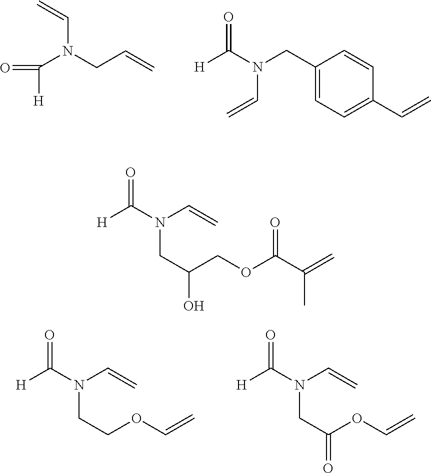

More preferred hybrid N-vinylformamide crosslinking moieties having at least one N-vinylformamide functionality and at least one other reactive vinyl functionality may be selected from the group consisting of:

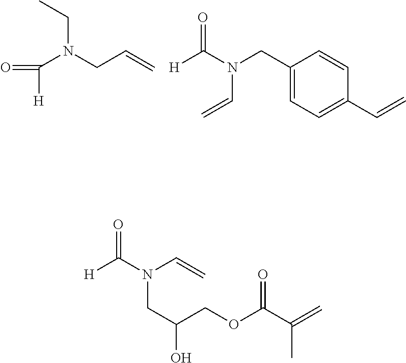

The present invention further provides compositions comprising a polymer resulting from polymerization of at least one reactive vinyl monomer moiety and a hybrid N-vinylformamide crosslinking moiety having at least one N-vinylformamide functionality and at least one other reactive vinyl functionality. Preferred compositions are adhesive, agricultural, beverage, cleaning, coating, encapsulation, membrane, personal care, and oilfield compositions. Preferred reactive monomer moieties and hybrid N-vinylformamide crosslinking moieties having at least one N-vinylformamide functionality and at least one other reactive vinyl functionality are as defined above.

The present invention further provides a polymer resulting from polymerization of at least one hybrid reactive N-vinylformamide monomer moiety having one N-vinylformamide functionality and at least one other reactive non-vinyl functionality and a multifunctional N-vinylformamide crosslinking moiety.

The at least one other reactive non-vinyl functionality in the hybrid reactive N-vinylformamide monomer moiety having one N-vinylformamide functionality and at least one other reactive non-vinyl functionality may be selected from the group consisting of epoxides, oxetanes, benzoxazines, oxazolines, and mixtures thereof. Preferred hybrid reactive N-vinylformamide monomer moieties having one N-vinylformamide functionality and at least one other reactive non-vinyl functionality may be selected from the group consisting of:

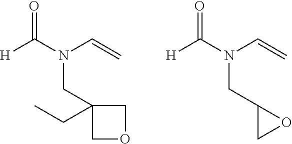

A more preferred hybrid reactive N-vinylformamide monomer moiety having one N-vinylformamide functionality and at least one other reactive non-vinyl functionality is:

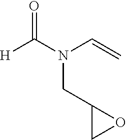

Preferred multifunctional N-vinylformamide crosslinking moieties may be selected from the group consisting of:

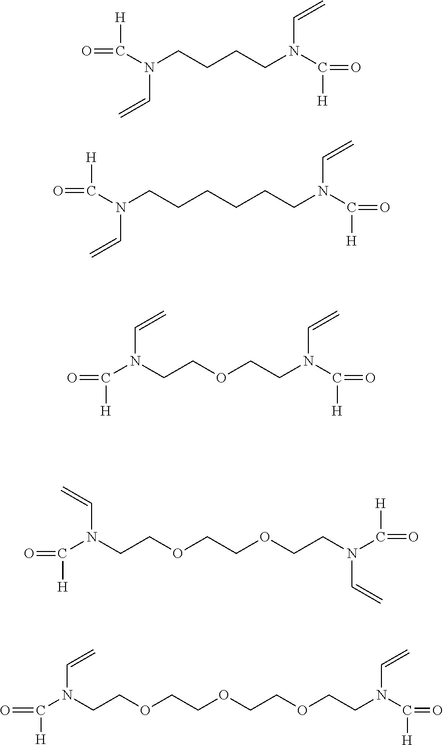 [SMILES: C=CN(C=O)CCCCN(C=C)C=O ; C=CN(C=O)CCCCCCN(C=C)C=O ; C=CN(C=O)CCOCCN(C=C)C=O ; C=CN(C=O)CCOCCOCCN(C=C)C=O ; C=CN(C=O)CCOCCOCCOCCN(C=C)C=O]

More preferred multifunctional N-vinylformamide crosslinking moieties may be selected from the group consisting of:

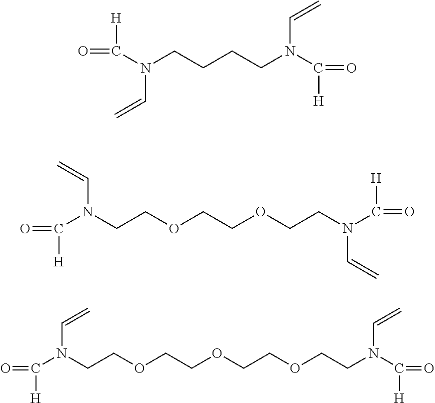

The present invention further provides compositions comprising a polymer resulting from polymerization of at least one hybrid reactive N-vinylformamide monomer moiety having one N-vinylformamide functionality and at least one other reactive non-vinyl functionality and a multifunctional N-vinylformamide crosslinking moiety. Preferred compositions are adhesive, agricultural, beverage, cleaning, coating, encapsulation, membrane, personal care, and oilfield compositions. Preferred hybrid reactive N-vinylformamide monomer moieties having one N-vinylformamide functionality and at least one other reactive non-vinyl functionality and multifunctional N-vinylformamide crosslinking moiety are as defined above.

The present invention further provides a polymer resulting from polymerization of at least one hybrid reactive N-vinylformamide monomer moiety having one N-vinylformamide functionality and at least one other reactive non-vinyl functionality and a hybrid N-vinylformamide crosslinking moiety having at least one N-vinylformamide functionality and at least one other reactive vinyl functionality.

The at least one other reactive non-vinyl functionality in the hybrid reactive N-vinylformamide monomer moiety having one N-vinylformamide functionality and at least one other reactive non-vinyl functionality may be selected from the group consisting of epoxides, oxetanes, benzoxazines, oxazolines, and mixtures thereof. Preferred hybrid reactive N-vinylformamide monomer moieties having one N-vinylformamide functionality and at least one other reactive non-vinyl functionality may be selected from the group consisting of:

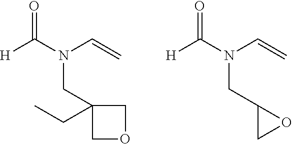

A more preferred hybrid reactive N-vinylformamide monomer moiety having one N-vinylformamide functionality and at least one other reactive non-vinyl functionality is:

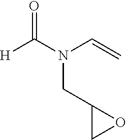

Preferred hybrid N-vinylformamide crosslinking moieties having at least one N-vinylformamide functionality and at least one other reactive vinyl functionality may be selected from the group consisting of:

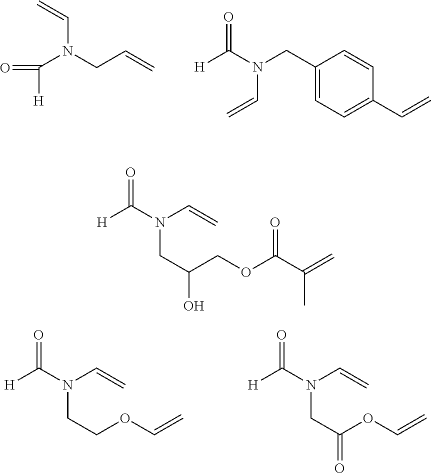

More preferred hybrid N-vinylformamide crosslinking moieties having at least one N-vinylformamide functionality and at least one other reactive vinyl functionality may be selected from the group consisting of:

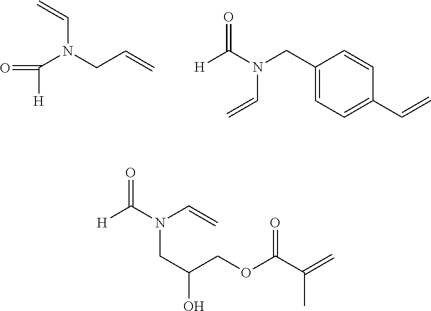

The present invention further provides compositions comprising a polymer resulting from polymerization of at least one hybrid reactive N-vinylformamide monomer moiety having one N-vinylformamide functionality and at least one other reactive non-vinyl functionality and a hybrid N-vinylformamide crosslinking moiety having at least one N-vinylformamide functionality and at least one other reactive vinyl functionality. Preferred compositions are adhesive, agricultural, beverage, cleaning, coating, encapsulation, membrane, personal care, and oilfield compositions. Preferred hybrid reactive N-vinylformamide monomer moieties having one N-vinylformamide functionality and at least one other reactive non-vinyl functionality and hybrid N-vinylformamide crosslinking moieties having at least one N-vinylformamide functionality and at least one other reactive vinyl functionality are as defined above.

The synthesis of the monomer crosslinkers and the polymers with crosslinkers of the present invention can be prepared according to the examples set out below. The examples arc presented for purposes of demonstrating, but not limiting, the preparation of the compounds and compositions of this invention.

### EXAMPLES

In accordance with the present invention, the following examples are provided to illustrate preferred methods for preparing the novel moieties,

### Example 1

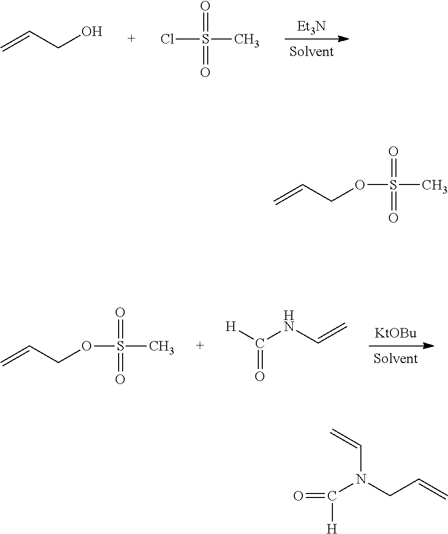

N-Allyl-N-vinylformamide was synthesized via a two-step reaction. The first step was the synthesis of Allyl Mesylate. Toluene (1175 g), Allyl Alcohol (116.2 g, 2.0 mol) and Triethylamine (253.0 g, 2.5 mol) were charged into a dry 3-L, four-neck flask fitted with a mechanical stirrer, temperature controller/thermocouple, reflux condenser, dropping funnel and nitrogen inlet. The mixture was cooled to 2-5° C., and then Methanesulfonyl Chloride (263.5 g, 2.3 mol) was added dropwise over 2 h while maintaining the temperature below 10° C. After the addition was complete, the reaction mixture was warmed to room temperature and stirred overnight. The reaction mixture became a yellow slurry. The mixture was then cooled to 2-5° C. and washed with cold water. The organic layer was concentrated and dried by a rotavapor at 50-55° C./3-4 mm Hg for 3 h to provide Allyl Mesylate, 201-214 g (97.5%-98.1% pure by GC).

The second step was the reaction of Allyl Mesylate with N-vinylformamide to form N-Allyl-N-vinylformamide. A dry 2-L, four-neck flask was fitted with a mechanical stirrer, temperature controller/thermocouple/heating mantle, reflux condenser, two dropping funnels and nitrogen inlet. The apparatus was purged with nitrogen for 0.5 h and charged with tert-Butyl Methyl Ether (MTBE) (774 g). The flask was cooled to 5-8° C. and Potassium tert-Butoxide (94.3 g, 0.84 mol) was added. N-vinylformamide (59.7 g, 0.84 mol) was added dropwise into the reactor within 1 h while maintaining the temperature below 10° C. The reaction mixture was then warmed to room temperature, stirred for 1 h, and then 200 mg of tert-Butylcatechol was added. Allyl Mesylate (95.3 g, 98.9% pure, 0.7 mol) was added while the temperature was kept below 50° C. The mixture was heated to 57-58° C., refluxed for 4 h, and then cooled to room temperature. After three washes with water, the organic layer was evaporated to remove solvent by a rotavapor. The products was dried at 35-40° C./3-4 mm 11 g for 3 h. The yield of the resulting product, N-Allyl-N-vinylformamide, was 68-71 g (98% pure, GC).

### Example 2

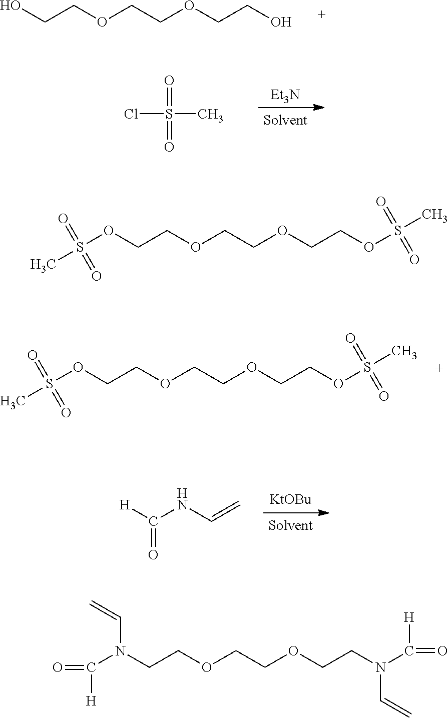

1,8-Di-(N-vinylformamido)-3,6-dioxyoctane was synthesized via a two-step reaction. The first step was the synthesis of Tri(ethylene glycol) Dimesylate. A dry 3-L, four-neck flask was fitted with a mechanical stirrer, temperature controller/thermocouple, reflux condenser, dropping funnel and nitrogen inlet. The apparatus was purged with nitrogen for 0.5 h. Ethyl Acetate (1245 g), Tri(ethylene glycol) (150.2 g, 1.0 mol) and Triethylamine (253.0 g, 2.5 mol) were added into the flask. The mixture was cooled to 2-5° C. and Methanesulfonyl Chloride (263.5 g, 2.3 mol) was added within 2 h while maintaining the temperature below 10° C. The mixture was warmed to room temperature, stirred overnight, and then cooled to 2-5° C. After two washes with cold water, the organic layer was concentrated by a rotavapor at 45-50° C./10-100 mm Hg and dried at 50° C./4-5 mm Hg for 1 h. Tri(ethylene glycol) Dimesylate was obtained with a yield of 297-302 g and a purity of 97.0-98.5% (GC analysis).

The second step was the reaction of Tri(ethylene glycol) Dimesylate with N-vinylformamide to form 1,8-Di-(N-vinylformamide)-3,6-dioxyoctane (DVFOO). In a dry 2-L, four-neck flask fitted with a mechanical stirrer, temperature controller/thermocouple/heating mantle, reflux condenser, two dropping funnels and a gas inlet, tent-Butyl Methyl Ether (MTBE) (567 g) was added. The reactor was cooled to 5-8° C. and Potassium tent-Butoxide 107.7 g (0.96 mol) was added with agitation. N-Vinylformamide (68.2 g, 0.96 mol) was then added over a 1 h period while maintaining the temperature below 10° C. The mixture was warmed to room temperature, stirred for 1 h, and then 300 mg of tert-Butylcatechol was added. Tri(ethylene glycol) Dimesylate (TEGD) (94.5% pure, 129.6 g, 0.4 mol) was added dropwise within 15 minutes, at a rate to maintain the temperature below 55° C. The mixture was refluxed for 4 h, cooled to 2-5° C., and then vacuum filtered. After silica treatment in presence of Hexane, the filtrate was concentrated by a rotavapor and dried at 40-45° C./3-4 mm Hg for 1 h. The yield of 1,8-Di-(N-vinylformamido)-3,6-dioxyoctane (DVFOO), was 71-79 g (GC: 99.3-99.4% pure).

### Example 3

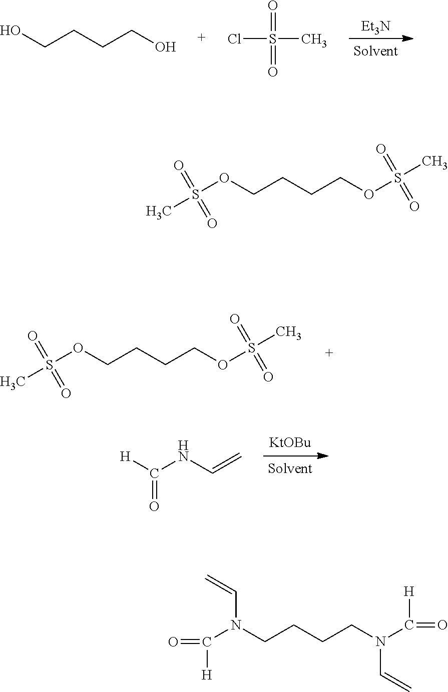

1,4-Di-(N-vinylformamido)butane (DVFR) was synthesized via a two-step reaction. The first step was the synthesis of 1,4-Butanediol Dimesylate. A dry 1-L, four-neck flask fitted with a mechanical stirrer, temperature controller/thermocouple, reflux condenser, dropping funnel and nitrogen inlet was purged with nitrogen for 0.5 h. Toluene (546 g), 1,4-Butanediol (27 g, 0.3 mol) and Triethylamine (75.9 g, 0.75 mol) were added into the flask. The mixture was cooled to 15° C. and Methanesulfonyl Chloride (79.0 g, 0.69 mol) was added within 2 h while maintaining the temperature 15-20° C. The reaction mixture was then warmed to room temperature and stirred overnight. The mixture (yellow slurry) was cooled to 2-5° C. and filtered. The precipitate was washed three times with cold water and dried in a vacuum oven to provide 67-67.4 g of 1,4-Butanediol Dimesylate (98.9-99.6%, by GC).

The second step was the reaction of 1,4-Butanediol Dimesylate with N-vinylformamide. A dry 2-L, four-neck flask was fitted with a mechanical stirrer, temperature controller/thermocouple/heating mantle, reflux condenser, dropping funnel and gas inlet. The apparatus was purged with nitrogen for 0.5 h and tert-Butyl Methyl Ether (MTBE) (403 g) was then added. The reactor was cooled to 5-8° C. and Potassium tert-Butoxide (67.3 g, 0.6 mol) was added with agitation. N-Vinylformamide (42.7 g, 0.6 mol) was added over a 1 h period while maintaining the temperature below 10° C. After the addition was complete, the mixture was slowly warmed to room temperature, stirred for 1 h, and then 150 mg of tert-Butylcatechol was added. Then, 1,4-Butoanediol Dimesylate (62.5 g, 0.25 mol, 98.5% pure) was added to the reaction mixture and the mixture was slowly heated to 57-58° C. After 4 h under reflux, the mixture was cooled to room temperature and washed three times with water. The organic layer was concentrated and dried by a rotavapor. The obtained product is 1,4-Di-(N-vinylformamido)butane (DVFB) (31.2-31.4 g, 98.7-98.8% pure, by GC).

### Example 4

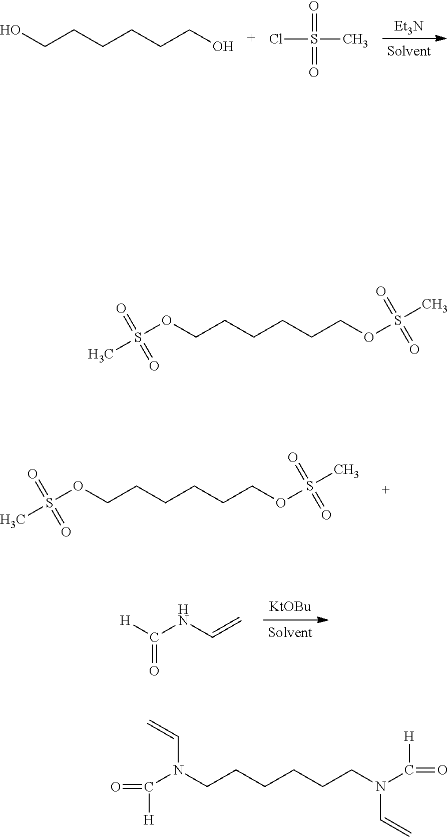

1,6-Di-(N-vinylformamido)hexane (DVFH) was synthesized via a two-step reaction. The first step was the synthesis of 1,6-Hexanediol Dimesylate. A dry 1-L, four-neck flask fitted with a mechanical stirrer, temperature controller/thermocouple, reflux condenser, dropping funnel and nitrogen inlet was purged with nitrogen for 0.5 h. Ethyl Acetate (1185 g), 1,6-Hexanediol (118.2 g, 1.0 mol) and Triethylamine (253.0 g, 2.5 mol) were added into the flask. The mixture was cooled to 5-8° C. and Methanesulfonyl Chloride (263.5 g, 2.3 mol) was added within 3 h while maintaining the temperature below 10° C. The reaction mixture was then warmed to room temperature and stirred overnight. Ethyl Acetate (300 g) was added and the mixture was washed three times with cold water. The organic layer was dried by a rotovapor. The yield of 1,6-Hexanediol Dimesylate was 271.9-272.9 g (97.1-97.8% pure by GC).

The second step was the reaction of 1,6-Hexanediol Dimesylate with N-vinylformamide. A dry 2-L, four-neck flask was fitted with a mechanical stirrer, temperature controller/thermocouple/heating mantle, reflux condenser, dropping funnel and gas inlet. After 0.5 h of nitrogen purge, tert-Butyl Methyl Ether (MTBE) (604 g) was charged into the reactor. The reactor was cooled to 5-8° C. and Potassium tert-Butoxide (121.2 g, 1.08 mol) was added with agitation. Then N-vinylformamide (76.8 g, 1.08 mol) was added over a 1 h period while maintaining the temperature below 10° C. After the addition was complete, the mixture was slowly warmed to room temperature, stirred for 1 h, and then 300 mg of tert-Butylcatechol was added. Then 1,6-Hexanediol Dimesylate (127.1 g, 97.1% pure, 0.45 mol) was added. The reaction mixture was slowly heated to 57-58° C. and refluxed in MTBE for 2 h. After three washes with water, the organic layer was treated with silica gel in the presence of hexane. The silica gel was washed with MTBE/hexane mixture three times. The collected filtrates were then concentrated and dried by a rotavapor to provide 1,6-Di-(N-vinylformamido)hexane (DVFH) (90 g, 97.7% pure by GC).

### Example 5

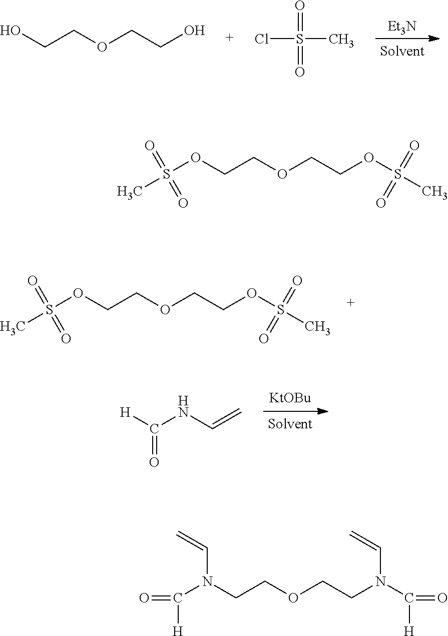

1,5-Di-(N-vinylformamido)-3-oxypentane was synthesized via a two-step reaction. The first step was the synthesis of Di(ethylene glycol) Dimesylate. A dry 3-L, four-neck flask was fitted with a mechanical stirrer, thermocouple/temperature controller, reflux condenser, dropping funnel and nitrogen inlet. The apparatus was purged with nitrogen for 0.5 h. MTBE (1460 g), Di(ethylene glycol) (106.1 g, 1.0 mol) and Triethylamine (253.0 g, 2.5 mol) were added to the flask. The mixture was cooled to 2-5° C. and Methanesulfonyl Chloride (263.5 g, 2.3 mol) was added within 2 h while maintaining the temperature below 10° C. The reaction mixture was then warmed to room temperature and stirred overnight. The mixture (yellow slurry) was cooled to 2-5° C. and filtered. After two washes with MTBE and two washes with water, the precipitate was dried overnight in a vacuum oven to provide Di(ethylene glycol) Dimesylate with a yield of 237 g and a purity of 95.5% (GC analysis).

The second step was the reaction of Di(ethylene glycol) Dimesylate with N-vinylformamide to form 1,5-Di-(N-vinylformamido)-3-oxypentane (DVFOP). A dry 3-L, four-neck flask was fitted with a mechanical stirrer, thermocouple/temperature controller/heating mantle, reflux condenser, dropping funnel and nitrogen inlet. The apparatus was purged with nitrogen for 0.5 h and MTBE (942 g) was added. The reactor was cooled to 5-8° C. and Potassium tert-Butoxide 188.5 g (1.68 mol) was added with agitation. N-vinylformamide (119.5 g, 1.68 mol) was then added dropwise over a 1 h period while maintaining the temperature below 10° C. The mixture was slowly warmed to room temperature, stirred for 1 h, and then 400 mg of tert-Butylcatechol was added. Di(ethylene glycol) Dimesylate (DEGD) (192.3 g, 95.5% pure, 0.7 mol) was then added within 0.5 h. The mixture was heated to 57-58° C., refluxed for 3 h, cooled to 2-5° C., and then filtrated. The precipitate was washed with MTBE. The filtrate was washed with water and treated with silica gel. After removing the silica gel, the filtrate was evaporated to dryness to provide 1,5-Di-(N-vinylformamido)-3-oxypentane (DVFOP) with a yield of 111 g and purity of 97.1% (by GC).

### Example 6

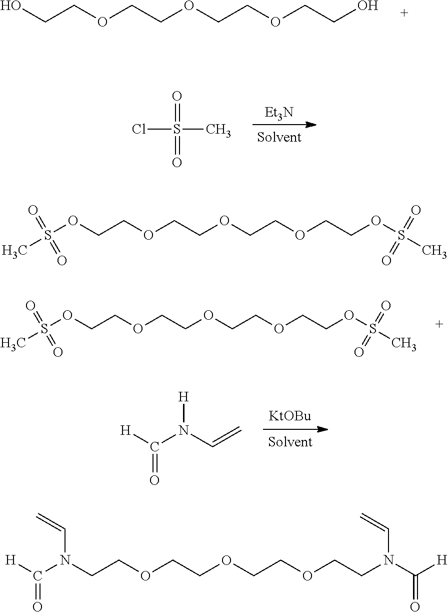

1,11-Di-(N-vinylformamido)-3,6,9-trioxyundecane was synthesized via a two-step reaction. The first step was the synthesis of Tetra(ethylene glycol) Dimesylate. A dry 3-L, four-neck flask was fitted with a mechanical stirrer, thermocouple/temperature controller, reflux condenser, dropping funnel and nitrogen inlet. The apparatus was purged with nitrogen for 0.5 h. Ethyl Acetate (1056 g), Tetra(ethylene glycol) (155.4 g, 0.8 mol) and Triethylamine (202.4 g, 2.0 mol) were added into the flask. The mixture was cooled to 2-5° C. and Methanesulfonyl Chloride (210.8 g, 1.84 mol) was added within 2 h while maintaining the temperature below 10° C. The reaction mixture was then warmed to room temperature and stirred overnight. After two washes with cold water, the organic layer was evaporated to dryness by a rotavapor to provide Tetra(ethylene glycol) Dimesylate with a yield of 268 g and a purity of 81.1% (GC analysis).

The second step was the reaction of Tetra(ethylene glycol) Dimesylate with N-vinylformamide to form 1,11-Di-(N-vinylformamido)-3,6,9-trioxyundecane (DVFTU). A dry 2-L, four-neck flask was fitted with a mechanical stirrer, temperature controller/thermocouple/heating mantle, reflux condenser, dropping funnel and nitrogen inlet. The apparatus was purged with nitrogen for 0.5 h and MTBE (506 g) was added. The reactor was cooled down to 5-8° C. and then Potassium tert-Butoxide 87.5 g (0.78 mol) was added with agitation. Then N-vinylformamide (55.4 g, 0.78 mol) was added within 1 h while maintaining the temperature below 10° C. The mixture was warmed to room temperature, stirred for 1 h, and then 250 mg of tert-Butylcatechol was added. Tetra(ethylene glycol) Dimesylate (129.6 g, 81.1% pure, 0.3 mol) was added within 0.5 h. The mixture was heated to 60-62° C., refluxed for 4 h, cooled to 2-5° C., and then filtrated. The precipitate was washed with cold MTBE. The collected filtrate was treated with silica gel in the presence of hexane. The filtrate was concentrated and dried by a rotavapor to provide 1,11-Di-(N-vinylformamido)-3,6,9-trioxyundecane (DVFTU) (73 g, 97.0% pure by GC).

### Example 7

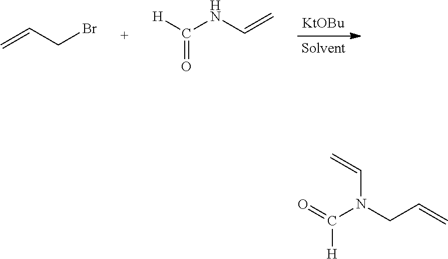

A dry 1-L, four-neck flask was fitted with mechanical stirrer, temperature controller/thermocouple/heating mantel, reflux condenser, dropping funnel and nitrogen inlet. The apparatus was purged with nitrogen for 0.5 h and charged with Toluene (387 g). The flask was cooled to 10-15° C. and 64.5 g of Potassium tert-Butoxide (0.575 mol) was added. N-vinylformamide (40.9 g, 0.575 mol) was then added within 0.5 h while maintaining the temperature below 25° C. When the addition was complete, the mixture was stirred for 1 h. Tert-Butylcatechol (140 mg) was added and stirring was continued for 1 h. The mixture was heated to 57-58° C. and Allyl Bromide (60.5 g, 0.5 mol) was added while the temperature was kept at 60-62° C. The reaction mixture was stirred at 60° C. for 4 h and then cooled to room temperature. The mixture was washed with water and NaCl aqueous solution. The collected organic layer was concentrated and dried by a rotavapor. The resulting product, N-Allyl-N-vinylformamide, was 41-42 g (98% pure, GC).

### Example 8

In a 1-L resin kettle equipped with an anchor type agitator, 129.55 g of water, 0.05 g of 20% aqueous NaOH solution and 135.0 g of N-vinyl pyrrolidone (VP) was charged. The reaction mixture was degassed with nitrogen and then heated to 100° C. During heating, 1.35 g of 1,8-Di-(N-vinylformamido)-3,6-dioxyoctane and 4.05 g of PVPP were added. The reaction mixture was refluxed at 100° C. for 6 h and then 600 g of water was added. The mixture was stirred at 90° C. for 1 h and then filtered. The precipitate was rinsed with 300 g water and treated with phosphoric acid solution at 90° C. for 1 h. The mixture was neutralized, filtered, and then dried to provide a crosslinked PVPP powder.

### Example 9

Heptane (1000 g) was charged into a 2-liter four-necked glass kettle equipped with feeding pumps, anchor agitator, thermocouple and condenser. After nitrogen purge, the reactor was heated to 62° C. A Feed I was prepared by mixing 100 g N-vinylpyrrolidone and 2.0 g 1,8-Di-(N-vinylformamido)-3,6-dioxyoctane. A Feed II was prepared by weighing 100 g of Acrylic Acid (AA) into a bottle. The Heptane was held at 62° C. for 0.5 h and then 0.344 g Trigonox 25 C75 and 1.0 g Di-tert-Butyl Peroxide (DTBP) were added into the kettle. Simultaneously, Feeds I and II were metered into the reactor over 4 h. After the feeding was complete, the reaction was held at 62° C. for 1 h, and then increased to 90° C. within 30 m in. A quantity of 0.158 g of Trigonox 25C75 was added every hour for a total of two times. After the last charge of Trigonox 25C75, the reaction was held for 1 h. The reaction mixture was cooled to 40° C., transferred to a 2-L high pressure reactor, and then charged with 1.0 g of Di-tent-Butyl Peroxide. After three purges with nitrogen, the reactor was heated to 120° C. The reaction was held for 10 h and then cooled to room temperature. Solvent was removed and the residual was dried in a vacuum oven to provide a white powder. Gas chromatography analysis showed that the residual N-vinylpyrrolidone was 0.13%. The polymer contains 62% crosslinked PVP.

### Example 10

Heptane (1000 g) was charged into a 2-liter four-necked glass kettle equipped with feeding pumps, anchor agitator, thermocouple and condenser. After a nitrogen purge, the reactor was heated to 62° C. A Feed I was prepared by mixing 100 g of N-vinylpyrrolidone and 2.0 g of 1,5-Di-(N-vinylformamido)-3-oxypentane. A Feed IT was prepared by weighing 100 g of Acrylic Acid (AA) into a bottle. The Heptane was held at 62° C. for 30 min, then 0.344 g of Trigonox 25 C75 and 1.0 g of Di-tert-Butyl Peroxide was added into the kettle. Simultaneously, Feeds I and II were metered into the reactor over 4 h. Alter the feeding was complete, the reaction was held at 62° C. for 1 h and then increased to 90° C. within 30 min. A quantity of 0.158 g of Trigonox 25C75 was added every hour for a total of 2 times. After the last charge of Trigonox 25C75, the reaction was held for 1 h. The reaction mixture was cooled to 40° C., transferred to a 2-L high pressure reactor then charged with 1.0 g of Di-tert-Butyl Peroxide. After three purges with nitrogen, the reactor was heated to 120° C. and held for 10 hours. The r reaction mixture was then cooled to room temperature. Solvent was removed and the residual was dried in a vacuum oven to provide a white powder. Gas chromatography analysis showed that the residual N-vinylpyrrolidone was 0.078%. The polymer contains 41-48% crosslinked PVP.

### Example 11

Heptane (1000 g) was charged into a 2-liter four-necked glass kettle equipped with feeding pumps, anchor agitator, thermocouple and condenser. After a nitrogen purge, the reactor was heated to 62° C. A Feed I was prepared by mixing 100 g of N-vinylpyrrolidone and 2.0 g of 1,8-Di-(N-vinylformamido)hexane. A Feed II was prepared by weighing 100 g of Acrylic Acid (AA) into a bottle. The Heptane was held at 62° C. for 30 min, then 0.344 g Trigonox 25 C75 and 1.0 g Di-tert-Butyl Peroxide were added into the kettle. Simultaneously, Feeds I and II were metered into the reactor over 4 h. After the feeding was complete, the reaction was held at 62° C. for 1 h and then increased to 90° C. within 30 min. A quantity of 0.158 g of Trigonox 25C75 was added every hour for a total of 2 times. After the last charge of Trigonox 25C75, the reaction was held for 1 h. The reaction mixture was cooled to 40° C., transferred to a 2-L high pressure reactor, and then charged with 1.0 g of d-t-butyl peroxide.

After three purges with nitrogen, the reactor was heated to 120° C., held for 10 h, and then cooled to room temperature. Solvent was removed and the residual was dried in a vacuum oven to provide a white powder. Gas chromatography analysis showed that the residual VP was <0.19%. The polymer contains 60-70% crosslinked PVP.

### Example 12

Heptane (1000 g) was charged into a 2-liter four-necked glass kettle equipped with feeding pumps, anchor agitator, thermocouple and condenser. After a nitrogen purge, the reactor was heated to 62° C. A Feed I was prepared by mixing 100 g of N-vinylpyrrolidone and 2.0 g of 1,4-Di-(N-vinylformamido)butane. A Feed II was prepared by weighing 100 g of Acrylic Acid (AA) into a bottle. The reaction was held at 62° C. for 30 min then 0.344 g Trigonox 25 C75 and 1.0 g Di-tert-Butyl Peroxide were added into the kettle. Simultaneously, Feeds I and II were metered into the reactor over 4 h. After the feeding was complete, the reaction was held at 62° C. for 1 h then increased to 90° C. A quantity of 0.158 g of Trigonox 25C75 was added every hour for a total of 2 times. The reaction was held for 1 h, cooled to 40° C., and then transferred to a 2-L high pressure reactor. A quantity of 1.0 g of d-t-butyl peroxide was added into the reactor. After three purges with nitrogen, the reactor was heated to 120° C., held for 10 h, and then cooled to room temperature. Solvent was removed and the residual was dried in a vacuum oven to provide a white powder. Gas chromatography analysis showed that the residual N-vinylpyrrolidone was <0.1%. The polymer contains 60-70% crosslinked PVP.

### Example 13

Heptane (1000 g) was charged into a 2-L four-neck resin kettle equipped with an anchor stirrer, thermocouple, one feeding tube, reflux condenser and gas inlet. After a nitrogen purge with agitation, the reactor was heated to 65° C. and held for 30 min. Then 520 μl Trigonox 25 C75 was charged and a premix of 0.90 g of 1,5-Di-(N-vinylformamido)-3-oxypentane and 200 g of N-vinylpyrrolidone was fed in over 6 h. The reaction was held at 65° C. for 1 h and 200 μl of Trigonox 25 C75 was charged. After 1 h of reaction, the mixture was cooled, transferred into a 2-L high pressure reactor and then 1.0 g of Luperox 101 was charged. The reaction mixture was heated to 130° C. and stirred for 10 h. The mixture was cooled to room temperature and dried to remove the solvent. The obtained product is a white powder. GC analysis showed the residual N-vinylpyrrolidone was less than 100ppm. The polymer contains 55-70% crosslinked PVP.

### Example 14

Heptane (1000 g) was charged into a 2-L four-neck resin kettle equipped with an anchor stirrer, thermocouple, one feeding tube, reflux condenser and gas inlet. After a nitrogen purge and agitation, the reactor was heated to 65° C. and held for 30 min. Then 520 μl Trigonox 25 C75 was charged and a premix of 0.90 g 1,8-Di-(N-vinylformamido)-3,6-dioxyoctane and 200 g N-vinylpyrrolidone was fed in over 6 h. The reaction was held at 65° C. for 1 h and 200 μl Trigonox 25 C75 was charged. After 1 h of reaction, the reaction mixture was cooled, transferred into a 2-L high pressure reactor then 1.0 g Luperox 101 was charged. The reaction mixture was heated to 130° C., stirred for 10 h then cooled to room temperature and dried to provide a white powder. GC analysis showed the residual N-vinylpyrrolidone was less than 100 ppm. The polymer contains 55-70% crosslinked PVP.

### Example 15

Heptane (1000 g) was charged into a 2-L four-neck resin kettle equipped with an anchor stirrer, thermocouple, one feeding tube, reflux condenser and gas inlet. After a nitrogen purge and agitation, the reactor was heated to 65° C. and held for 30 min. Then 520 μl Trigonox 25 C75 was charged and a premix of 0.90 g of 1,4-Di-(N-vinylformamido)butane and 200 g of N-vinylpyrrolidone was fed in over 6 h. The reaction was held at 65° C. for 1 h and 200 Trigonox 25 C75 was charged. After 1 h of reaction, the reaction mixture was cooled, transferred into a 2-L high pressure reactor, then 1.0 g Luperox 101 was charged. The reaction mixture was heated to 130° C., stirred for 10 h then cooled to room temperature and dried to provide a white powder. GC analysis showed the residual N-vinylpyrrolidone was less than 100 ppm. The polymer contains 55-70% crosslinked PVP.

### Example 16

Heptane (1000 g) was charged into a 2-L four-neck resin kettle equipped with an anchor stirrer, thermocouple, one feeding tube, reflux condenser and gas inlet. After a nitrogen purge and agitation, the reactor was heated to 65° C. and held for 30 min. Then 520 μl Trigonox 25 C75 was charged and a premix of 0.90 g of 1,6-Di-(N-vinylformamido)hexane and 200 g of N-vinylpyrrolidone was fed in over 6 h. The reaction was held at 65° C. for 1 h and 200 μl Trigonox 25 C75 was charged. After 1 h of reaction, the reaction mixture was cooled, transferred into a 2-L high pressure reactor, then 1.0 g Luperox 101 was charged. The reaction mixture was heated to 130° C., stirred for 10 h then cooled to room temperature and dried to provide a white powder. GC analysis showed the residual N-vinylpyrrolidone was less than 100 ppm. The polymer contains 55-70% crosslinked PVP.

### Example 17

In a 1-L resin kettle equipped with an anchor agitator, thermocouple, gas inlet and reflux condenser, 100 g of N-vinylpyrrolidone, 200 g of water and 0.7 g of 1,8-Di-(N-vinylformamide)-3,6-dioxyoctane were charged. The reaction mixture was purged with nitrogen for 30 min and 0.649 g of NH₄OH aqueous solution (26%) was added. With agitation and nitrogen purging, the reactor was heated to 65° C., then 1.79 g of 35% H₂O₂ aqueous solution was added followed by 0.01 g of 0.12% CuSO₄. After 15 min of reaction, 0.67 g of H₂O₂ was charged into the reactor. The reaction was held for 15 min then 0.55 g of H₂O₂ was charged into the reactor. After 3 h, the reaction mixture was cooled to room temperature to discharge the product. GC analysis showed the residual N-vinylpyrrolidone was less than 100 ppm. The K value (1% aqueous solution) of the polymer obtained was 36.0±3

### Example 18

In a 1-L resin kettle equipped with an anchor agitator, thermocouple, gas inlet and reflux condenser, 100 g of N-vinylpyrrolidone, 200 g of water and 1.0 g of 1,8-Di-(N-vinylformamide)-3,6-dioxyoctane were charged. The reaction mixture was purged with nitrogen for 30 min and 0.649 g NH₄OH aqueous solution (26%) was added. After vigorous agitation and nitrogen purging, the reactor was heated to 65° C. then 1.79 g of 35% H₂O₂ aqueous solution was added followed by 0.01 g of 0.12% CuSO₄. After 15 min, 0.67 g of H₂O₂ was charged into the reactor. The reaction was held for 15 min and then 0.55 g of H₂O₂ was charged. After 3 h, the reaction mixture was cooled to room temperature to discharge the product. GC analysis showed the residual N-vinylpyrrolidone was less than 100 ppm. The K value (1% aqueous solution) of the polymer obtained was 55.0±5.

### Example 19

In a 1-L resin kettle equipped with an anchor agitator, thermocouple, gas inlet, reflux condenser and nitrogen blanket, 75 g of N-vinylpyrrolidone, 200 g of water and 0.7 g of 1,8-Di-(N-vinylformamido)-3,6-dioxyoctane were charged. The reaction mixture was purged with nitrogen for 30 min and 0.649 g of NH₄OH aqueous solution (26%) was added. The reactor was heated to 65° C. then 1.887 g of H₂O₂ was added followed by 0.01 g of 0.12% CuSO₄. After 15 min, Then 25 g of N-vinylpyrrolidone were added and temperature increased to 87° C. When the temperature dropped to 80° C., the reaction was maintained for 0.5 h and 0.67 g of 35% H₂O₂ aqueous solution was charged. After 15 min, H₂O₂ (0.55 g, 35% aqueous solution) was added into the reactor. The reaction was maintained for 3 h then cooled to room temperature to discharge the product. GC analysis showed the residual N-vinylpyrrolidone was less than 0.5%. The K value (1% aqueous solution) of the polymer obtained was 42±4.

### Example 20

In a 1-L resin kettle equipped with an anchor agitator, thermocouple, gas inlet and reflux condenser, 100 g of N-vinylpyrrolidone, 200 g of water and 1.0 g of N-allyl-(N-vinylformamide) were charged. The reaction mixture was purged with nitrogen for 30 min and 0.649 g of NH₄OH aqueous solution (26%) was added. With agitation and nitrogen purging, the reactor was heated to 65° C. A quantity of 1.79 g of 35% H₂O₂ aqueous solution was added followed by 0.01 g of 0.12% CuSO₄. After 15 min, 0.67 g of H₂O₂ (35% in water) was charged into the reactor. The reaction was held for 15 min and then 0.55 g of H₂O₂ was added into the reactor. The reaction was maintained for 3 h then cooled to room temperature to discharge the product. GC analysis showed the residual N-vinylpyrrolidone was less than 60 ppm. The K-value of this polymer in 1% aqueous solution was 38±5.

While a number of embodiments of this invention have been represented, it is apparent that the basic construction can be altered to provide other embodiments that utilize the invention without departing from the spirit and scope of the invention. All such modifications and variations are intended to be included within the scope of the invention as defined in the appended claims rather than the specific embodiments that have been presented by way of example.

We claim:

1. A polymer resulting from polymerization of at least one reactive vinyl monomer moiety and a multifunctional N-vinylformamide crosslinking moiety.

2. The polymer according to claim 1, wherein the at least one reactive vinyl monomer moiety is selected from the group consisting of maleic anhydrides, vinyl amides, acrylates, styrenes, maleimides, maleates, fumarates, cinnamyls, vinyl imidazoles, vinyl pyridines, vinyl acetates, acrylamides, vinyl sulfones, vinyl carbonates, vinyl silanes, vinyl acrylamides, allyl derivatives, vinyl ethers, and mixtures thereof.

3. The polymer according to claim 1, wherein the multifunctional N-vinylformamide crosslinking moiety is selected from the group consisting of:

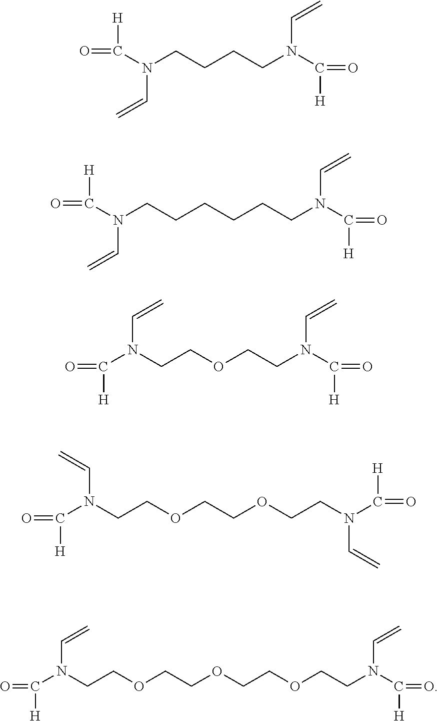 [SMILES: C=CN(C=O)CCCCN(C=C)C=O ; C=CN(C=O)CCCCCCN(C=C)C=O ; C=CN(C=O)CCOCCN(C=C)C=O ; C=CN(C=O)CCOCCOCCN(C=C)C=O ; C=CN(C=O)CCOCCOCCOCCN(C=C)C=O]

4. A composition comprising a polymer resulting from polymerization of at least one reactive vinyl monomer moiety and a multifunctional N-vinylformamide crosslinking moiety.

5. The composition according to claim 4, wherein the composition is selected from the group consisting of adhesives, aerosols, agricultural compositions, beverages, cleaning compositions, coating compositions, cosmetic formulations, dental compositions, detergents, drugs, encapsulations, foods, hair sprays, lithographic solutions, membrane formulations, oilfield formulations, personal care compositions, pharmaceuticals, and pigment dispersions.

6. The composition according to claim 4, wherein the at least one reactive vinyl monomer moiety is selected from the group consisting of maleic anhydrides, vinyl amides, acrylates, styrenes, maleimides, maleates, fumarates, cinnamyls, vinyl imidazoles, vinyl pyridines, vinyl acetates, acrylamides, vinyl sulfones, vinyl carbonates, vinyl silanes, vinyl acrylamides, allyl derivatives, vinyl ethers, and mixtures thereof.

7. The composition according to claim 4, wherein the multifunctional N-vinylformamide crosslinking moiety is selected from the group consisting of:

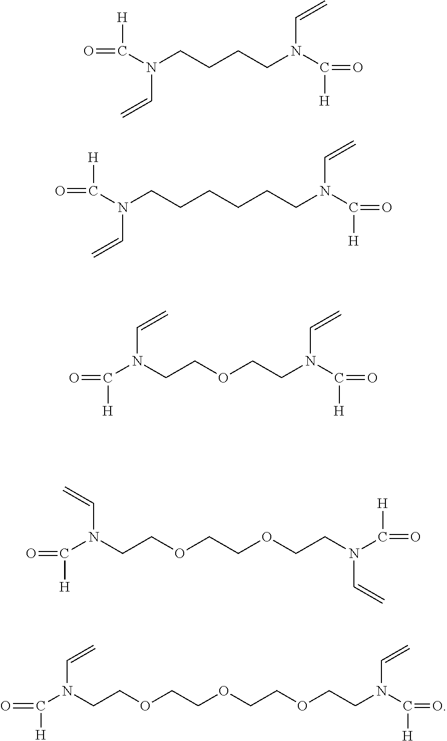 [SMILES: C=CN(C=O)CCCCN(C=C)C=O ; C=CN(C=O)CCCCCCN(C=C)C=O ; C=CN(C=O)CCOCCN(C=C)C=O ; C=CN(C=O)CCOCCOCCN(C=C)C=O ; C=CN(C=O)CCOCCOCCOCCN(C=C)C=O]

8. A polymer resulting from polymerization of at least one reactive vinyl monomer moiety and a hybrid N-vinylformamide crosslinking moiety having at least one N-vinylformamide functionality and at least one other reactive vinyl functionality.

9. The polymer according to claim 8, wherein the at least one reactive vinyl monomer moiety is selected from the group consisting of maleic anhydrides, vinyl amides, acrylates, styrenes, maleimides, maleates, fumarates, cinnamyls, vinyl imidazoles, vinyl pyridines, vinyl acetates, acrylamides, vinyl sulfones, vinyl carbonates, vinyl silanes, vinyl acrylamides, allyl derivatives, vinyl ethers, and mixtures thereof.

10. The polymer according to claim 8, wherein the hybrid N-vinylformamide crosslinking moiety having at least one N-vinylformamide functionality and at least one other reactive vinyl functionality is selected from the group consisting of

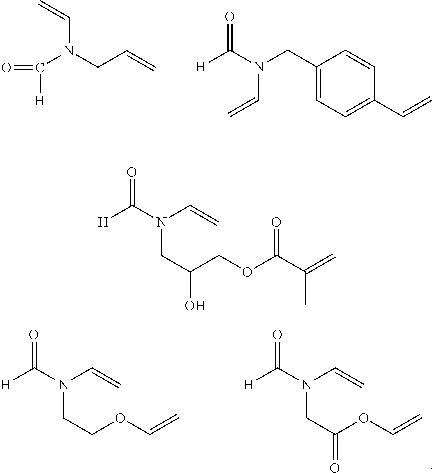

11. A composition comprising a polymer resulting from polymerization of at least one reactive vinyl monomer moiety and a hybrid N-vinylformamide crosslinking moiety having at least one N-vinylformamide functionality and at least one other reactive vinyl functionality.

12. The composition according to claim 11, wherein the composition is selected from the group consisting of adhesives, aerosols, agricultural compositions, beverages, cleaning compositions, coating compositions, cosmetic formulations, dental compositions, detergents, drugs, encapsulations, foods, hair sprays, lithographic solutions, membrane formulations, oilfield formulations, personal care compositions, pharmaceuticals, and pigment dispersions.

13. The composition according to claim 11, wherein the at least one reactive vinyl monomer moiety is selected from the group consisting of maleic anhydrides, vinyl amides, acrylates, styrenes, maleimides, maleates, fumarates, cinnamyls, vinyl imidazoles, vinyl pyridines, vinyl acetates, acrylamides, vinyl sulfones, vinyl carbonates, vinyl silancs, vinyl acrylamides, allyl derivatives, vinyl ethers, and mixtures thereof.

14. The composition according to claim 11, wherein the hybrid N-vinylformamide crosslinking moiety having at least one N-vinylformamide functionality and at least one other reactive vinyl functionality is selected from the group consisting of:

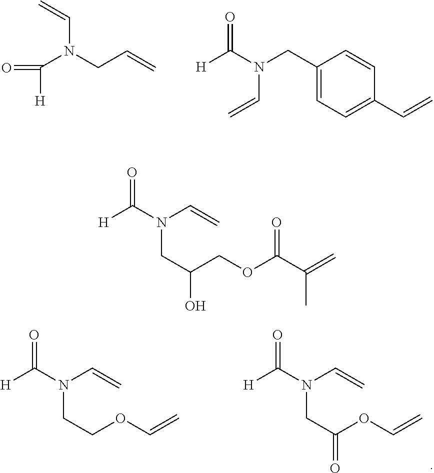

15. A polymer resulting from polymerization of at least one hybrid reactive N-vinylformamide monomer moiety having one N-vinylformamide functionality and at least one other reactive non-vinyl functionality and a multifunctional N-vinylformamide crosslinking moiety.

16. The polymer according to claim 15, wherein the at least one other reactive non-vinyl functionality in the hybrid reactive N-vinylformamide monomer moiety having one N-vinylformamide functionality and at least one other reactive non-vinyl functionality is selected from the group consisting of epoxides, oxetanes, benzoxazines, oxazolines, and mixtures thereof.

17. The polymer according to claim 15, wherein the multifunctional N-vinylformamide crosslinking moiety is selected from the group consisting of:

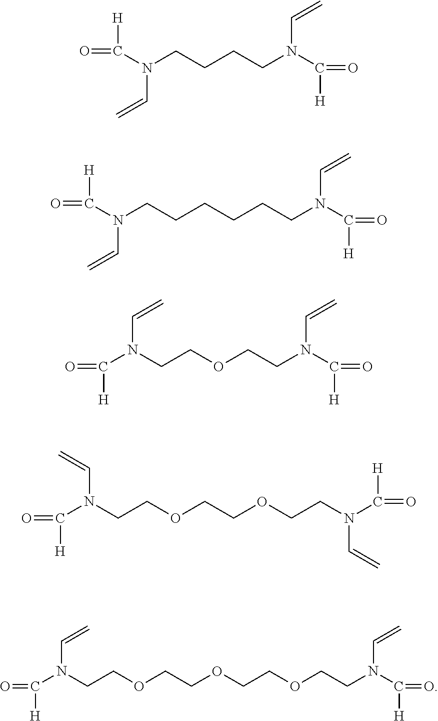 [SMILES: C=CN(C=O)CCCCN(C=C)C=O ; C=CN(C=O)CCCCCCN(C=C)C=O ; C=CN(C=O)CCOCCN(C=C)C=O ; C=CN(C=O)CCOCCOCCN(C=C)C=O ; C=CN(C=O)CCOCCOCCOCCN(C=C)C=O]

18. A composition comprising a polymer resulting from polymerization of at least one hybrid reactive N-vinylformamide monomer moiety having one N-vinylformamide functionality and at least one other reactive non-vinyl functionality and a multifunctional N-vinylformamide crosslinking moiety.

19. The composition according to claim 18, wherein the composition is selected from the group consisting of adhesives, aerosols, agricultural compositions, beverages, cleaning compositions, coating compositions, cosmetic formulations, dental compositions, detergents, drugs, encapsulations, foods, hair sprays, lithographic solutions, membrane formulations, oilfield formulations, personal care compositions, pharmaceuticals, and pigment dispersions.

20. The composition according to claim 18, wherein the at least one other reactive non-vinyl functionality in the hybrid reactive N-vinylformamide monomer moiety having one N-vinylformamide functionality and at least one other reactive non-vinyl functionality is selected from the group consisting of epoxides, oxetanes, benzoxazines, oxazolines, and mixtures thereof.

21. The composition according to claim 18, wherein the multifunctional N-vinylformamide crosslinking moiety is selected from the group consisting of:

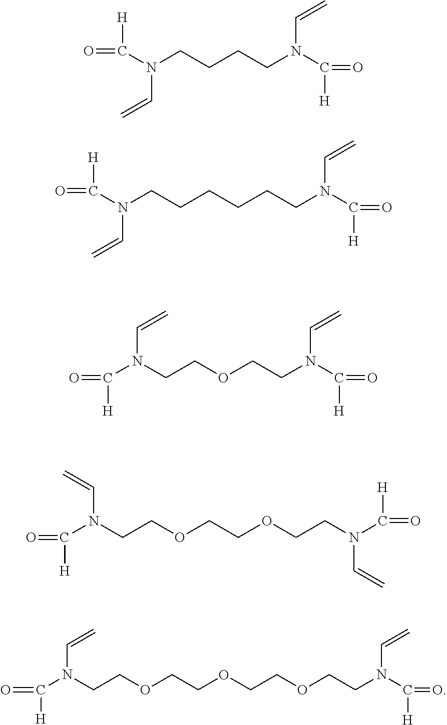 [SMILES: C=CN(C=O)CCCCN(C=C)C=O ; C=CN(C=O)CCCCCCN(C=C)C=O ; C=CN(C=O)CCOCCN(C=C)C=O ; C=CN(C=O)CCOCCOCCN(C=C)C=O ; C=CN(C=O)CCOCCOCCOCCN(C=C)C=O]

22. A polymer resulting from polymerization of at least one hybrid reactive N-vinylformamide monomer moiety having one N-vinylformamide functionality and at least one other reactive non-vinyl functionality and a hybrid N-vinylformamide crosslinking moiety having at least one N-vinylformamide functionality and at least one other reactive vinyl functionality.

23. The polymer according to claim 22, wherein the at least one other reactive non-vinyl functionality in the hybrid reactive N-vinylformamide monomer moiety having one N-vinylformamide functionality and at least one other reactive non-vinyl functionality is selected from the group consisting of epoxides, oxetanes, benzoxazines, oxazolines, and mixtures thereof.

24. The polymer according to claim 22, wherein the hybrid N-vinylformamide crosslinking moiety having at least one N-vinylformamide functionality and at least one other reactive vinyl functionality is selected from the group consisting of:

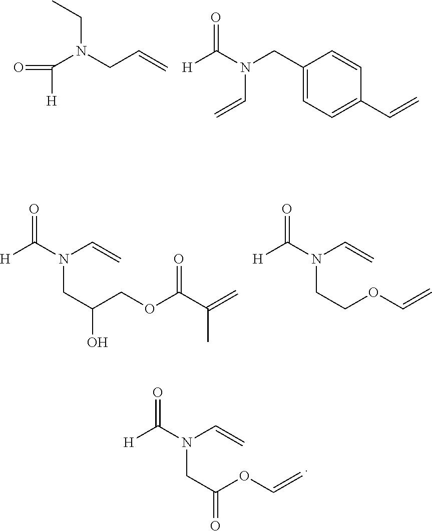

25. A composition comprising a polymer resulting from polymerization of at least one hybrid reactive N-vinylformamide monomer moiety having one N-vinylformamide functionality and at least one other reactive non-vinyl functionality and a hybrid N-vinylformamide crosslinking moiety having at least one N-vinylformamide functionality and at least one other reactive vinyl functionality.

26. The composition according to claim 25, wherein the composition is selected from the group consisting of adhesives, aerosols, agricultural compositions, beverages, cleaning compositions, coating compositions, cosmetic formulations, dental compositions, detergents, drugs, encapsulations, foods, hair sprays, lithographic solutions, membrane formulations, oilfield formulations, personal care compositions, pharmaceuticals, and pigment dispersions.

27. The composition according to claim 25, wherein the at least one other reactive non-vinyl functionality in the hybrid reactive N-vinylformamide monomer moiety having one N-vinylformamide functionality and at least one other reactive non-vinyl functionality is selected from the group consisting of epoxides, oxetanes, benzoxazines, oxazolines, and mixtures thereof.

28. The composition according to claim 25, wherein the hybrid N-vinylformamide crosslinking moiety having at least one N-vinylformamide functionality and at least one other reactive vinyl functionality is selected from the group consisting of: [chemical structure]
